(19) United States
(12) Patent Application Publication
(10) Pub. No.: US 2004/0059774 A1
(43) Pub. Date: Mar. 25, 2004

(54) System and method for efficiently distributing data

(75) Inventors: Brian MacIsaac, Kanata (CA); Greg Lehman, Ottawa (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Catena Networks, Inc., Redwood Shores, CA

(21) Appl. No.: 10/616,496

(22) Filed: Jul. 8, 2003

(30) Foreign Application Priority Data
Jul. 9, 2002 (CA) 2,392,809

(51) Int. Cl. G06F 15/16

(52) U.S. Cl. 709/202; 709/234

(57) ABSTRACT

A telecommunication system (such as a switch) connects a plurality of subscriber lines to a telecommunications network, and includes a common element. The common element, including a data management agent, is provided for distributing data from a source location to a set of hardware entities, which are subtended from the common element. The data management agent includes a transfer agent, a buffer pool and a plurality of download agents. The transfer agent retrieves the data from the source location and stores it in the buffer pool. The download agents retrieve the data from the buffer pool and transmit the retrieved data to a corresponding hardware entity. Thus, the efficiency for transferring data from the source location to the hardware entities is improved.

### CROSS-REFERENCES TO RELATED APPLICATIONS

In accordance with 35 U.S.C. § 119, priority is claimed from Canadian Application Number 2,392,809, filed Jul. 9, 2002.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates generally to a system and method for efficiently distributing data, specifically in a network environment with distributed network components.

Referring to FIG. 1, an example of a distributed network system is illustrated generally by numeral 100. The system comprises a common element (CE) 102 and a plurality of subtended hardware entities 104. Examples of hardware entities 104 include Broadband Loop Carriers (BLCs), Digital Subscriber Loop Access Multiplexers (DSLAMs), line cards, and the like. The CE 102 is a central control card that manages the various functions of the system 100 and the subtended hardware entities 104. The CE 102 is further coupled to a file server 106 for receiving software updates. Typically, the file server 106 is a remote File Transfer Protocol (FTP) server, which stores the software images.

The following procedure described the steps required to either upgrade or install new software on the hardware entities 104. Image management software at the CE 102 establishes an FTP session to the file server 106, which contains a software image to be loaded onto a destination hardware entity 104. The software is to be stored on the hardware entity 104 in the form of a file. Thus, a destination file is opened on the hardware entity 104 in preparation for the file transfer.

New software, or a software upgrade, is transferred to the CE 102. However, there is often not enough memory available at the CE 102 to hold a complete software image for any of the subtended hardware entities 104. Thus, the software is transferred to the CE 102 in blocks. The blocks are sized so that they can be stored in the CE's memory. As each block arrives at the CE 102, it is temporarily stored in memory. The block is then transferred to the destination file on the hardware entity 104. The CE 102 then retrieves the next block from the file server 106 and continues this process until the entire file is transferred. When the software image has been completely transferred to the hardware entity 104, the file is closed and the FTP session is terminated.

This whole process is repeated for the next hardware entity that requires the same software image, including establishing a new FTP session and transferring the file across the network.

As it can be seen, performing a software upgrade to a system that contains multiple instances of the same hardware is time consuming as each hardware entity must be upgraded individually. This problem is compounded when the system contains multiple hardware entities that require different versions of the software.

Therefore, it is an object of the present invention to obviate or mitigate at least some of the above mentioned disadvantages.

### BRIEF SUMMARY OF THE INVENTION

It is an advantage of the present invention that software upgrade performance is improved and an overall time required to upgrade a system is reduced as compared with the prior art.

In accordance with an aspect of the present invention, there is provided a common element including a data management agent for distributing data from a source location to a set of hardware entities, which are subtended from said common element, said data management agent comprising: a transfer agent for retrieving said data from said source location; a buffer pool for storing said retrieved data; and a plurality of download agents, each for retrieving said data from said buffer pool and transmitting said retrieved data to a corresponding hardware entity.

In accordance with another aspect of the present invention, there is provided a method for distributing data from a source location to a set of hardware entities subtended from a common element comprising the steps of: retrieving at said common element said data from said source location; storing said data in a buffer pool at said common element; and transmitting, in parallel, data from said data pool to each hardware entity in said set of hardware entities.

In accordance with yet another aspect of the present invention, there is provided a data carrier comprising instructions for performing a method for distributing data from a source location to a set of hardware entities subtended from a common element, the data carrier comprising: code for retrieving, at the common element, the data from the source location; code for storing the data in a buffer pool at the common element; and code for transmitting, in parallel, data from the data pool to each hardware entity in the set of hardware entities.

### BRIEF DESCRIPTION OF THE DRAWINGS

Embodiments of the invention will now be described by way of example only, with reference to the following drawings in which:

FIG. 1 is a block diagram of a distributed network system (prior art);

FIG. 2 is a block diagram of a distributed network system in accordance with an embodiment of the invention;

FIG. 3 is a flow chart illustrating the operation of downloading software in accordance with the embodiment of the invention illustrated in FIG. 2; and

FIG. 4 is a block diagram of a distributed network system in accordance with an alternate embodiment of the invention.

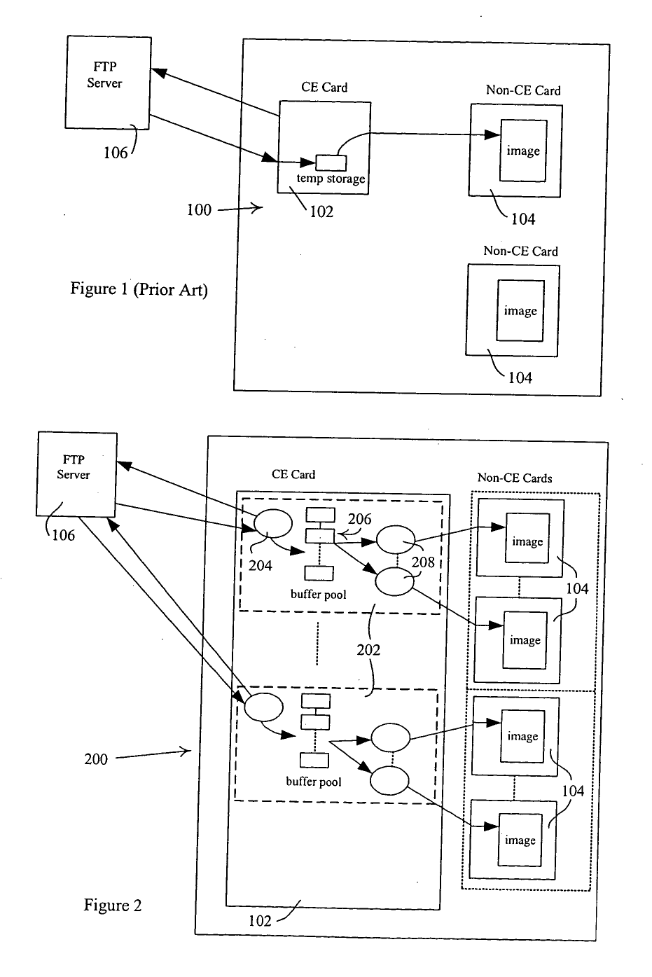

### DETAILED DESCRIPTION OF THE INVENTION

For convenience, like numerals in the description refer to like structures in the drawings. Referring to FIG. 2, a distributed network system in accordance with an embodiment of the invention is illustrated generally by numeral 200. The system 200 comprises a CE 102, a plurality of subtended hardware entities 104, and a file server 106 as described with reference to the prior art. In the present embodiment, however, the CE 102 further includes a plurality of instances of a software management agent 202, which are managed by image management software. Each instance of the software management agent 202 is responsible for downloading software common to a plurality of hardware entities 104. Each of the software management agents 202 includes a transfer agent 204, a buffer pool 206, and a plurality of download agents 208. Typically, each download agent 208 is associated with one of the hardware entities 104.

The transfer agent 204 is typically a task or thread of execution that manages the transfer of the software image from the file server 106 to the buffer pool 206. The download agents 208 are typically tasks or threads of execution that handle the transfer of the software image from the buffer pool 206 to the hardware entities 104. Thus, for example, if a system comprises 20 line cards of the same type, 20 download agent tasks 208 are created.

A buffer pool 206 is used to temporarily store the software image. As described with reference to the prior art, if the software image size is greater than the size of available memory, in this case the buffer pool 206, the software image is transferred in blocks. These blocks are stored by the buffer pool 206 so that they can be transferred by the download agents 208. The number of buffers in the buffer pool 206 as well as the individual buffer size of each buffer in the pool is determined by the image management software while creating the software management agent 202.

Further, this architecture can be leveraged such that groupings, or sets, of hardware entities 104 can be organized for different hardware entities in the system. The sets can be arranged in accordance with the hardware entity type, version, or other convenient grouping factor. The set can then be used to simultaneously download software for each of the hardware entities 104. Thus, for example, a first group of hardware entities will receive a software download from a first software agent, and a second group of hardware entities will receive a software download from a second software agent.

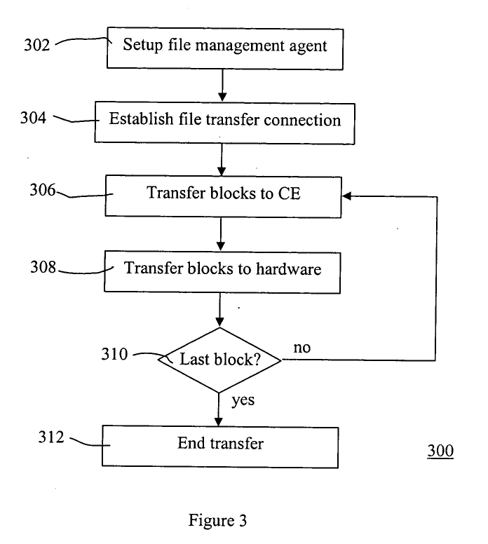

Referring to FIG. 3, a flow chart illustrating the operation of the software download in accordance with the present embodiment is illustrated generally by numeral 300. At step 302, the image management software instantiates a software management agent 202. The software management agent 202 includes a transfer agent 204, a buffer pool 206, and a plurality of download agents 208. The number of download agents 208 preferably corresponds to the number of hardware entities 104 receiving the software download.

As previously mentioned, the size of the buffer pool 206 is determined by the image management software. The size of the buffer pool 206, as well as each buffer in the buffer pool 206, is determined in accordance a number of factors, as will be apparent to a person skilled in the art upon review of this description. For example, if it is determined that a single software download is required (that is, only one software management agent 202 is instantiated), all of the memory available for software download is assigned to the buffer pool 206. Alternately, if multiple software downloads are required at the same time, that is multiple software management agents 202 are instantiated, the memory available for software download is partitioned between the buffer pools 206 of the different software management agents 202.

Yet further, if, for example, a preferred number of buffers in the buffer pool 206 is fixed, then the size of each buffer in the buffer pool is determined in accordance with the allotted memory. Alternately, if, for example, a preferred size of each buffer in the buffer pool 206 is fixed, then the number of buffers in the buffer pool 206 is determined in accordance with the allotted memory.

In step 304, the software management agent 202 establishes an FTP session with the file server 106 for the duration of the software image transfer. In step 306, the transfer agent 204 begins to transfer blocks of the software image from the file server 106 to the buffer pool 206. Preferably, the size of each block transferred corresponds to the size of a buffer in the buffer pool 206.

In step 308, each of the download agents 208 accesses the buffer pool 206 and transfers the program block stored therein to its corresponding hardware entity 104. Thus, it can be seen that the download agents 208 access the buffer pool in parallel, thereby reducing the time required to download a common software image to a plurality of hardware entities.

Furthermore, it is a goal of the image management software to minimize the time between the transfer agent 204 loading a block into the buffer pool 206 and the download agent 208 downloading the block to the plurality of hardware entities 104. Such a reduction in time will improve the efficiency of transferring the software image from the file server 106 to the hardware entities 104. The image management software can adjust the buffer pool depth dynamically, that is the number of buffers that comprise the buffer pool 206, to trade off required memory versus performance. This balancing is performed due to the real-time processor impact and responsiveness, as well as the lack of available memory.

In step 310, it is determined whether the block transferred by the transfer agent 204 was the last block of the software image. If the previously transferred block is not the last block of the image, the operation returns to step 306, and the transfer agent 204 retrieves the next block from the file server 106 and places it in the buffer pool 206. If the previously transferred block is the last block of the image, the operation proceeds to step 312. In step 312, the FTP connection to the file server 106 is terminated and the download agents 208 continue to transmit blocks until the buffer pool 206 is empty.

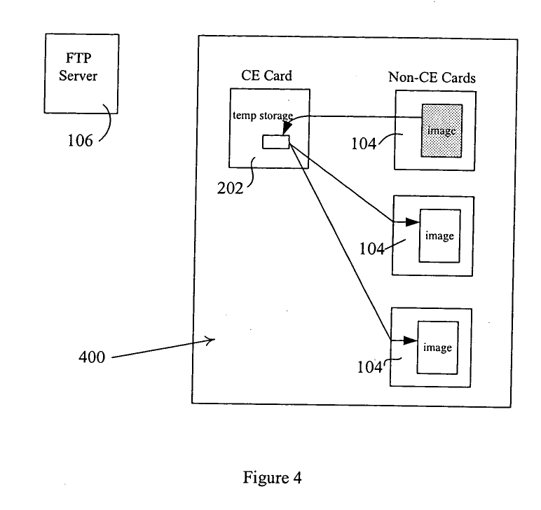

Referring to FIG. 4, a distributed network system in accordance with an alternate embodiment of the invention is illustrated generally by numeral 400. In the present embodiment, the CE image management software reads a previously transferred software image from one of the hardware entities 104, rather than the file server 106. The image is then written into multiple similar hardware entities 104 in parallel, as described with reference to the previous embodiment.

Thus, it can be seen that the present invention provides several advantages of the prior art. Multiple like hardware entities having the same software images can be upgraded, while requiring only one image transfer from a remote server. RAM used on the CE card can be dynamically controlled, improving the overall transfer performance. Also, one or more like hardware entities can be upgraded using a previously transferred software image from another similar hardware entity.

The software management agent 202 may generally correspond to a data carrier, code segment or computer program embodied on a computer-readable medium. Such computer-readable medium may be a portion of the memory of the CE card 102, which may be random access memory. The computer-readable medium may also include ROM, a disk drive, an electronic signal transmitted via wired or wireless carrier, etc.

Also, also the previous embodiment was described with reference to using FTP for file transfers, the invention is not limited to this protocol. Similarly, although the description makes specific reference to software, it can be applied to all forms of data. Thus, it will be appreciated that variations of some elements are possible to adapt the invention for specific conditions or functions. The concepts of the present invention can be further extended to a variety of other applications that are clearly within the scope of this invention. Having thus described the present invention with respect to a preferred embodiments as implemented, it will be apparent to those skilled in the art that many modifications and enhancements are possible to the present invention without departing from the basic concepts as described in the preferred embodiment of the present invention. Therefore, what is intended to be protected by way of Letters Patent should be limited only by the scope of the following claims.

What is claimed is:

1. For a telecommunication system connecting a plurality of subscriber lines to a telecommunications network, a common element including a data management agent for distributing data from a source location to a set of hardware entities subtended from said common element, said data management agent comprising:
(a) a transfer agent for retrieving said data from said source location;
(b) a buffer pool for storing said data being retrieved; and
(c) a plurality of download agents, each for retrieving said data from said buffer pool and transmitting said data being retrieved to a corresponding hardware entity.

2. A common element as defined in claim 1, further comprising:
a plurality of data management agents, each corresponding to one of a plurality of sets of hardware entities, wherein said data management agent is one of said plurality of data management agents.

3. A common element as defined in claim 1, wherein said buffer pool comprises a plurality of buffers.

4. A common element as defined in claim 3, wherein a number of said plurality of buffers in said buffer pool is assigned dynamically.

5. A common element as defined in claim 3, wherein a size of each of said plurality of buffers in said buffer pool is assigned dynamically.

6. A common element as defined in claim 5, wherein said size is determined in accordance with an available memory size and a number of data management agents operating simultaneously.

7. A common element as defined in claim 1, wherein said source location is a file server.

8. A common element as defined in claim 7, wherein said file server is remotely located.

9. A common element as defined in claim 1, wherein said source location is a previously updated hardware entity.

10. For a telecommunication system connecting a plurality of subscriber lines to a telecommunications network, a method for distributing data from a source location to a set of hardware entities subtended from a common element, comprising the steps of:
(a) retrieving at said common element said data from said source location;
(b) storing said data in a buffer pool at said common element; and
(c) transmitting, in parallel, said data from said buffer pool to each hardware entity in said set of hardware entities.

11. A method as defined in claim 10, further comprising:
a plurality of sets of hardware entities, each receiving said data from said source location.

12. A method as defined in claim 10, wherein said buffer pool comprises a plurality of buffers.

13. A method as defined in claim 12, wherein a number of said plurality of buffers in said buffer pool is assigned dynamically.

14. A method as defined in claim 12, wherein a size of each of said plurality of buffers in said buffer pool is assigned dynamically.

15. A method as defined in claim 14, wherein said size is determined in accordance with an available memory size and a number of sets of hardware entities operating simultaneously.

16. A method as defined in claim 10, wherein said source location is a file server.

17. A method as defined in claim 16, wherein said file server is remotely located.

18. A method as defined in claim 10, wherein said source location is a previously updated hardware entity.

19. For a telecommunication system connecting a plurality of subscriber lines to a telecommunication network, a data carrier embodied in a computer-readable medium, said data carrier including instructions for performing a method for distributing data from a source location to a set of hardware entities subtended from a common element, said data carrier comprising:
(a) code for retrieving at said common element said data from said source location;
(b) code for storing said data in a buffer pool at said common element; and
(c) code for transmitting, in parallel, said data from said buffer pool to each hardware entity in said set of hardware entities.
